(19) United States
(12) Patent Application Publication
(10) Pub. No.: US 2017/0175810 A1
(43) Pub. Date: Jun. 22, 2017

(54) Tapered Roller Bearing

(71) Applicant: JTEKT CORPORATION, Osaka (JP)

(72) Inventor: Akiyuki SUZUKI, Nagoya-shi (JP)

(73) Assignee: JTEKT CORPORATION, Osaka (JP)

(21) Appl. No.: 15/373,597

(22) Filed: Dec. 9, 2016

(30) Foreign Application Priority Data
Dec. 17, 2015 (JP) 2015-245960

(51) Int. Cl. F16C 19/36; F16C 33/66

(52) U.S. Cl. CPC F16C 19/364; F16C 33/6651; F16C 2240/42

(57) ABSTRACT

An outer ring has an annular step provided on an outer peripheral surface of the outer ring and forming an annular thin walled portion at an axial end of the outer ring. An axially inward end surface of a tubular portion of a lubricant holding member contacts the step of the outer ring, and an inner peripheral surface of the tubular portion contacts an outer peripheral surface of the thin walled portion. An annular groove is formed at a coupling portion between the step of the outer ring and the outer peripheral surface of the thin walled portion.

### INCORPORATION BY REFERENCE

The disclosure of Japanese Patent Application No. 2015-245960 filed on Dec. 17, 2015 including the specification, drawings and abstract, is incorporated herein by reference in its entirety.

### BACKGROUND OF THE INVENTION

1. Field of the Invention

The invention relates to a tapered roller bearing, and in particular, to a tapered roller bearing that stores a lubricant in a space where tapered rollers roll.

2. Description of the Related Art

A tapered roller bearing includes an outer ring, an inner ring, a plurality of tapered rollers, and a cage. The tapered rollers are arranged such that an axis of each roller around which the roller rolls is inclined with respect to an axis of the tapered roller bearing. A large-diameter bottom face (hereinafter also referred to as a roller large end face) of the tapered roller is arranged outward of a small-diameter bottom face (hereinafter also referred to as a roller small end face) in a radial direction of the bearing.

The tapered roller bearing characteristically needs to offer enhanced resistance to seizure between the roller large end faces of the tapered rollers and a surface of the inner ring that contacts the roller large end faces (hereinafter referred to as a cone back face rib surface) and to suppress wear of a pocket surface of the cage of the tapered roller bearing. As such a tapered roller bearing, a tapered roller bearing is known in which a lubricant holding member is attached to the outer ring so that a lubricant can be stored in a space between the lubricant holding member and the outer ring (for example, Japanese Patent Application Publication No. 2008-223891 (JP 2008-223891 A)).

In a tapered roller bearing 900 described in JP 2008-223891, a step 913 is formed at an end of an outer peripheral surface of an outer ring 910 as depicted in FIG. 9. Consequently, the outside diameter of an end 914 of the outer ring 910 is slightly smaller than the outside diameter of a central portion 912 of the outer ring 910. A cylindrical portion 952 of a lubricant holding member 950 is press-fitted to the end 914 of the outer ring 910. The cylindrical portion 952 is press-fitted to the outer ring 910 in an axial direction. The cylindrical portion 952 is press-fitted to the outer ring 910 until an end of the cylindrical portion 952 comes into contact with the step 913.

The step 913 of the outer ring 910 is formed by turning. As depicted in FIG. 10, normally, turning is performed by machining an outer peripheral surface of the outer ring 910 using a turning tool K. A tip of the turning tool K is normally rounded as depicted in FIG. 10. Thus, when the step 913 is formed using the turning tool K, then at a coupling portion between the step 913 and an outer peripheral surface 915 of the end 914, an unmachined portion 919 is present axially outward of a plane 913P that is an extension of a principal surface of the step 913 and radially outward of a plane 915P that is an extension of a principle surface of the outer peripheral surface 915 of the end 914.

If the unmachined portion 919 is present at the step 913 as depicted in FIG. 10, when the lubricant holding member 950 is fitted to the outer ring 910, the lubricant holding member 950 and the unmachined portion 919 interfere with each other. The lubricant holding member 950 may then be deformed. When deformed, the lubricant holding member 950 may protrude outward of the outer peripheral surface of the outer ring 910 in the radial direction. Then, during rotation of the bearing, a load may be imposed on an outer peripheral surface of the lubricant holding member 950 and the outer ring 910, posing problems such as cracking of the outer ring 910.

Deformation of the lubricant holding member 950 may result in an unintended clearance between the outer ring 910 and the lubricant holding member 950, leading to the decrease of sealing performance of the lubricant.

Deformation of the lubricant holding member 950 further leads to unstable contact between the step 913 of the outer ring 910 and an axially inward end surface of the cylindrical portion 952 of the lubricant holding member 950. Thus, when the tapered roller bearing 900 is assembled to another member such as a housing, an axial force applied to the axially inward end surface of the lubricant holding member 950 may cause the lubricant holding member 950 to be deflected with respect to the outer ring 910, making an assembly operation difficult and inefficient.

### SUMMARY OF THE INVENTION

An object of the invention is to provide a tapered roller bearing that is highly durable, that prevents the decrease in the sealing performance of lubricant, and that enables an easy and efficient operation of attaching the bearing to a housing.

A tapered roller bearing in an aspect of the invention includes an outer ring having a first raceway surface on an inner peripheral surface of the outer ring and an annular step provided on an outer peripheral surface of the outer ring and forming an annular thin walled portion at an axial end of the outer ring, an inner ring having a second raceway surface on an outer peripheral surface of the inner ring and arranged coaxially with the outer ring, a plurality of tapered rollers arranged in a space between the first raceway surface and the second raceway surface, a cage that holds the tapered rollers, and a lubricant holding member fixed integrally to the outer ring. The lubricant holding member has a circular-ring-like annular portion and a cylindrical tubular portion having an axially outward end connected to a radially outward end of the annular portion, the tubular portion being fixed to the outer ring such that an axially inward end surface of the tubular portion contacts the step of the outer ring in an axial direction and that an inner peripheral surface of the tubular portion contacts an outer peripheral surface of the thin walled portion in a radial direction. An annular groove is formed at a coupling portion between the step of the outer ring and the outer peripheral surface of the thin walled portion.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view depicting a general configuration of a tapered roller bearing in a first embodiment;

FIG. 2 is a sectional view depicting a part of the tapered roller bearing in the first embodiment;

FIG. 3 is a perspective view of a cage;

FIG. 4 is a sectional view depicting a part of the tapered roller bearing in the first embodiment;

FIG. 5 is a diagram illustrating a method for turning an outer ring;

FIG. 6 is a sectional view of an outer ring and a lubricant holding member in a first variation;

FIG. 7 is a sectional view of an outer ring and a lubricant holding member in a second variation;

FIG. 8 is a sectional view of an outer ring and a lubricant holding member in a second embodiment;

FIG. 9 is a sectional view depicting a part of a conventional tapered roller bearing; and

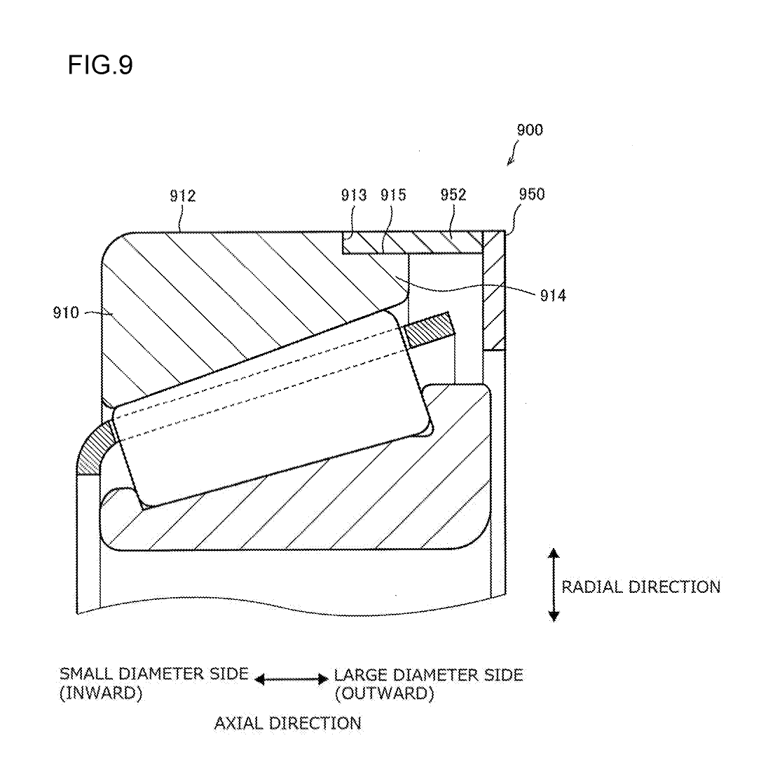

FIG. 10 is a diagram illustrating a method for turning an outer ring in the conventional configuration.

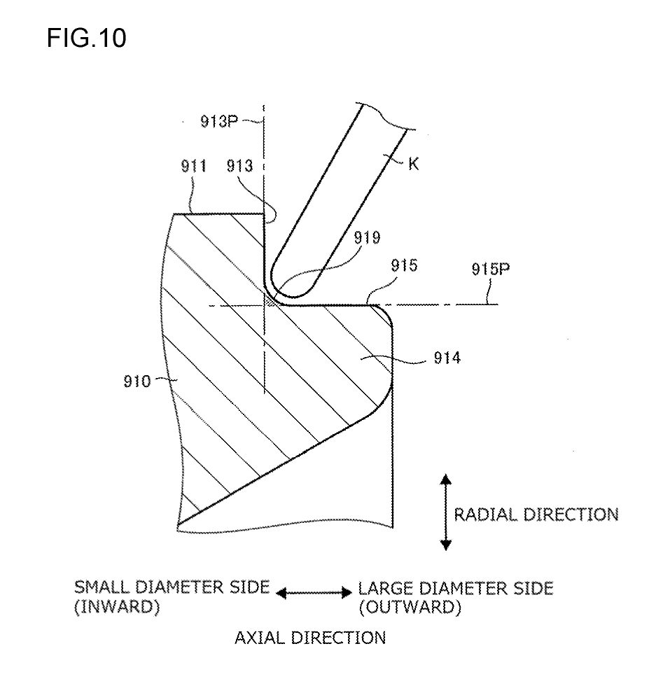

### DETAILED DESCRIPTION OF EMBODIMENTS

A tapered roller bearing in an aspect of the invention includes an outer ring, an inner ring, a plurality of tapered rollers, a cage, and a lubricant holding member. The outer ring has a first raceway surface on an inner peripheral surface of the outer ring and an annular step provided on an outer peripheral surface of the outer ring and forming an annular thin walled portion at an axial end of the outer ring. The inner ring has a second raceway surface on an outer peripheral surface of the inner ring and is arranged coaxially with the outer ring. The tapered rollers are arranged in a space between the first raceway surface and the second raceway surface. The cage holds the tapered rollers. The lubricant holding member is fixed integrally to the outer ring. The lubricant holding member has a circular-ring-like annular portion and a cylindrical tubular portion. The tubular portion has an axially outward end connected to a radially outward end of the annular portion. The tubular portion is fixed to the outer ring such that an axially inward end surface of the tubular portion contacts the step of the outer ring in an axial direction and that an inner peripheral surface of the tubular portion contacts an outer peripheral surface of the thin walled portion in a radial direction. An annular groove is formed at a coupling portion between the step of the outer ring and the outer peripheral surface of the thin walled portion.

In the above-described configuration, the annular groove is formed at the coupling portion between the step of the outer ring and the outer peripheral surface of the thin walled portion. Thus, when a step portion is formed by machining the outer peripheral surface of the outer ring using a turning tool, then at the coupling portion between the outer peripheral surface of the thin walled portion and the step, the outer ring is machined to a depth deeper than a plane resulting from intersection of a plane that is an extension of a principal surface of the outer peripheral surface and a plane that is an extension of a principal surface of the step. Consequently, when the lubricant holding member is fitted to the outer ring such that the inner peripheral surface of the tubular portion of the lubricant holding member comes into contact with the outer peripheral surface of the thin walled portion of the outer ring and that the axially inward end surface of the tubular portion comes into contact with the step of the outer ring, the tubular portion is restrained from being deformed.

As described above, the tubular portion is restrained from being deformed when the lubricant holding member is fitted to the outer ring. This restrains the tubular portion of the lubricant holding member from being deformed and protruding outward of the outer peripheral surface of the outer ring in the radial direction. Therefore, the above-described configuration enables prevention of problems such as cracking of the outer ring resulting from a load imposed on the outer peripheral surface of the tubular portion and the outer ring during rotation of the bearing, leading to enhanced durability.

The tubular portion is restrained from being deformed when the lubricant holding member is fitted to the outer ring. This suppresses formation of an unintended clearance between the outer ring and the lubricant holding member. Therefore, the above-described configuration enables the decrease of the sealing performance to be prevented.

The tubular portion is restrained from being deformed when the lubricant holding member is fitted to the outer ring. Consequently, the step of the outer ring stably contacts the axially inward end surface of the tubular portion of the lubricant holding member. Therefore, in the above-described configuration, when the tapered roller bearing is assembled to another member such as a housing, the lubricant holding member is restrained from being deflected with respect to the outer ring in spite of an axial force applied to the axially inward end surface of the lubricant holding member. As a result, the above-described configuration enables an easy and efficient operation of assembling the tapered roller bearing to another member.

A radial depth of the groove of the tapered roller bearing in the invention is preferably set to 2 mm or less in order to suppress a decrease in the strength of the outer ring.

A tapered roller bearing according to another embodiment of the invention includes an outer ring, an inner ring, a plurality of tapered rollers, a cage, and a lubricant holding member. The outer ring has a first raceway surface on an inner peripheral surface of the outer ring and an annular step provided on an outer peripheral surface of the outer ring and forming an annular thin walled portion at an axial end of the outer ring. The inner ring has a second raceway surface on an outer peripheral surface of the inner ring and is arranged coaxially with the outer ring. The tapered rollers are arranged in a space between the first raceway surface and the second raceway surface. The cage holds the tapered rollers. The lubricant holding member is fixed integrally to the outer ring. The lubricant holding member has a circular-ring-like annular portion and a cylindrical tubular portion. The tubular portion has an axially outward end connected to a radially outward end of the annular portion. The tubular portion is fixed to the outer ring such that an axially inward end surface of the tubular portion contacts the step of the outer ring in an axial direction and that an inner peripheral surface of the tubular portion contacts an outer peripheral surface of the thin walled portion in a radial direction. An annular underfill portion is formed at a coupling portion between the axially inward end surface of the tubular portion of the lubricant holding member and the inner peripheral surface of the tubular portion.

When a step portion is formed by machining the outer peripheral surface of the outer ring using a turning tool, the outer ring fails to be machined to a target depth. As a result, the coupling portion between the outer peripheral surface of the thin walled portion and the step may be positioned radially outward of a plane that is an extension of a principal surface of the outer peripheral surface of the thin walled portion and axially outward of a plane that is an extension of a principle surface of the step (an unmachined portion is left). In the above-described configuration, the annular underfill portion is formed at the coupling portion between the axially inward end surface of the tubular portion of the lubricant holding member and the inner peripheral surface of the tubular portion. The unmachined portion is fitted into the space of the underfill portion of the tubular portion of the lubricant holding member. Consequently, the unmachined portion can be restrained from interfering with the lubricant holding member. Therefore, when the lubricant holding member is fitted to the outer ring such that the inner peripheral surface of the tubular portion of the lubricant holding member comes into contact with the outer peripheral surface of the thin walled portion of the outer ring and that the axially inward end surface of the tubular portion comes into contact with the step of the outer ring, the tubular portion is restrained from being deformed.

As described above, the tubular portion is restrained from being deformed when the lubricant holding member is fitted to the outer ring. This restrains the tubular portion of the lubricant holding member from being deformed and protruding outward of the outer peripheral surface of the outer ring in the radial direction. Therefore, the above-described configuration enables prevention of problems such as cracking of the outer ring resulting from a load imposed on the outer peripheral surface of the tubular portion and the outer ring during rotation of the bearing, leading to enhanced durability.

The tubular portion is restrained from being deformed when the lubricant holding member is fitted to the outer ring. This suppresses formation of an unintended clearance between the outer ring and the lubricant holding member. Therefore, the above-described configuration enables decrease in the sealing performance of lubricant to be prevented.

The tubular portion is restrained from being deformed when the lubricant holding member is fitted to the outer ring. Consequently, the step of the outer ring stably contacts the axially inward end surface of the tubular portion of the lubricant holding member. Therefore, in the above-described configuration, when the tapered roller bearing is assembled to another member such as a housing, the lubricant holding member is restrained from being deflected with respect to the outer ring in spite of an axial force applied to the axially inward end surface of the lubricant holding member. As a result, the above-described configuration enables an easy and efficient operation of assembling the tapered roller bearing to another member.

A preferred embodiment of the invention will be described below in detail with reference to the drawings. In the drawings referred to below, only main members of the component members of the embodiment of the invention are depicted in a simplified manner for convenience of description. Therefore, the invention may include any component members not depicted in the drawings. The dimensions of the members in the drawings do not truly represent the actual dimensions, the dimensional ratio of the members, or the like.

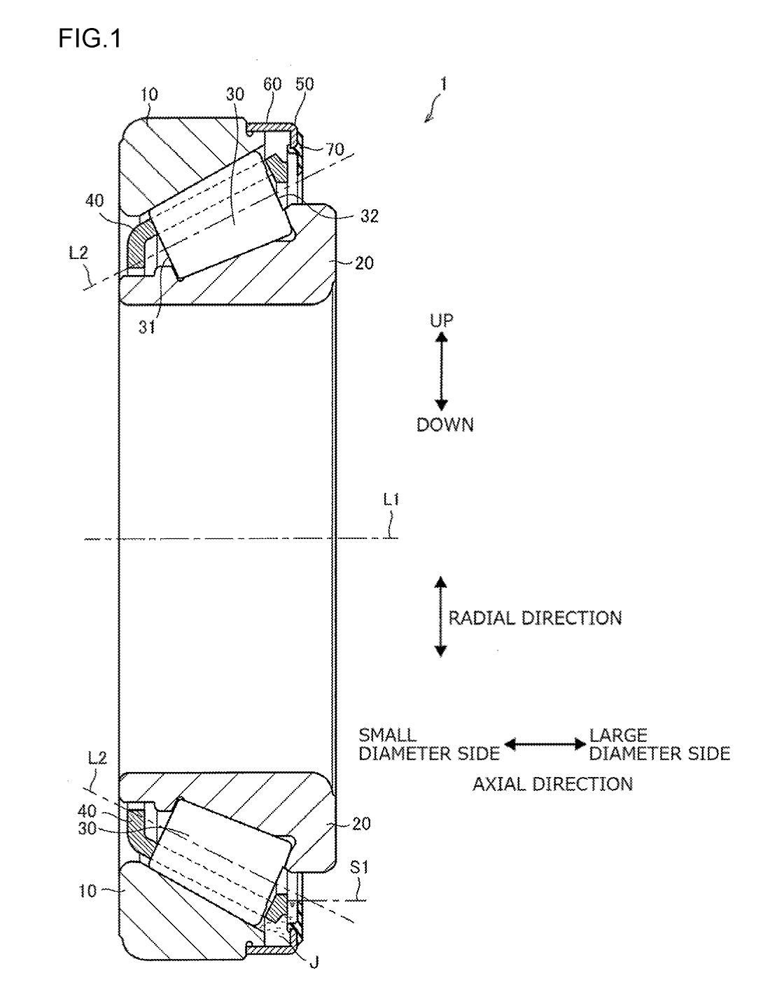

FIG. 1 is a sectional view of a tapered roller bearing 1 in a first embodiment. FIG. 1 is a sectional view of the tapered roller bearing 1 taken along a bearing axis L1. The tapered roller bearing 1 is used, for example, for a bearing apparatus for driving wheels in a vehicle such as an automobile. The “axial direction” as simply referred to herein means the axial direction of the bearing axis L1.

As depicted in FIG. 1, the tapered roller bearing 1 includes an outer ring 10, an inner ring 20, a plurality of tapered rollers 30, a cage 40, and a lubricant holding member 50. The outer ring 10, the inner ring 20, the cage 40, and the lubricant holding member 50 are annular members each having an axis that coincides with the bearing axis L1 of the tapered roller bearing 1.

As depicted in FIG. 1, the outer ring 10 and the inner ring 20 are arranged such that the inner ring 20 is fitted inward of the outer ring 10 in the radial direction. The cage 40 is arranged in a space between the outer ring 10 and the inner ring 20 in the radial direction. The tapered rollers 30 are held by the cage 40. The lubricant holding member 50 is attached to one end of the outer ring 10 in the axial direction.

Each of the tapered rollers 30 is shaped like a truncated cone. A roller axis L2 of the tapered roller 30 is inclined with respect to the bearing axis L1. The distance between the roller axis L2 and the bearing axis L1 increases from a small-diameter-side bottom face 31 (hereinafter also referred to as a small end face 31) toward a large-diameter-side bottom face 32 (hereinafter also referred to as a large end face 32) of the tapered roller 30.

In the description below, the side on which the small end face 31 of the tapered roller 30 is located in the axial direction is referred to as a “small diameter side”. The side on which the large end face 32 of the tapered roller 30 is located in the axial direction is referred to as a “large diameter side”.

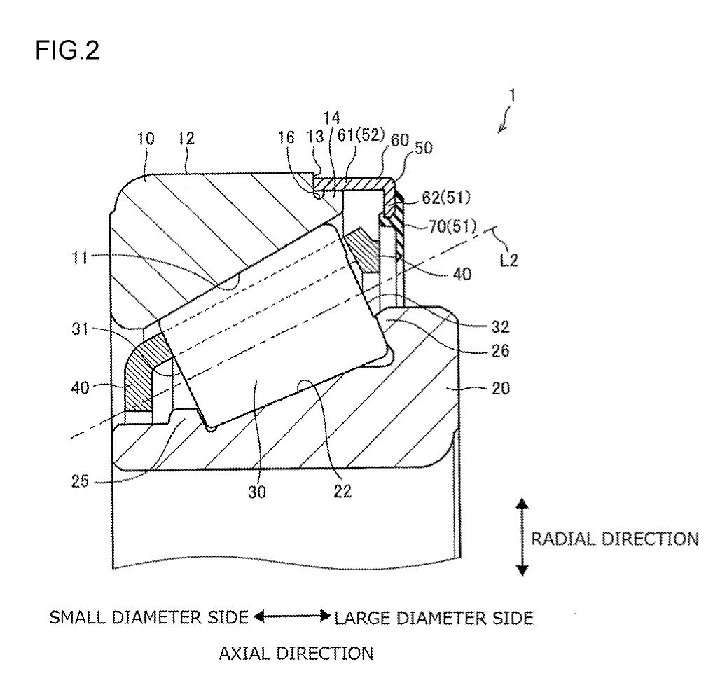

FIG. 2 is an enlarged sectional view of a part of the tapered roller bearing 1.

The outer ring 10 has a first raceway surface 11 on an inner peripheral surface of the outer ring 10. The first raceway surface 11 is tapered such that the distance between the first raceway surface 11 and the bearing axis L1 increases from the small diameter side toward the large diameter side.

An annular step 13 is formed on an outer peripheral surface 12 of the outer ring 10 along a circumferential direction. The step 13 is formed on the large diameter side in the axial direction with respect to a central portion of the outer ring 10. A thin walled portion 14 having a smaller radial thickness than a portion of the outer ring 10 located axially inward of the step 13 is present axially outward of the step 13 of the outer ring 10. The step 13 and the thin walled portion 14 are formed to allow the lubricant holding member 50 to be fitted to the outer ring.

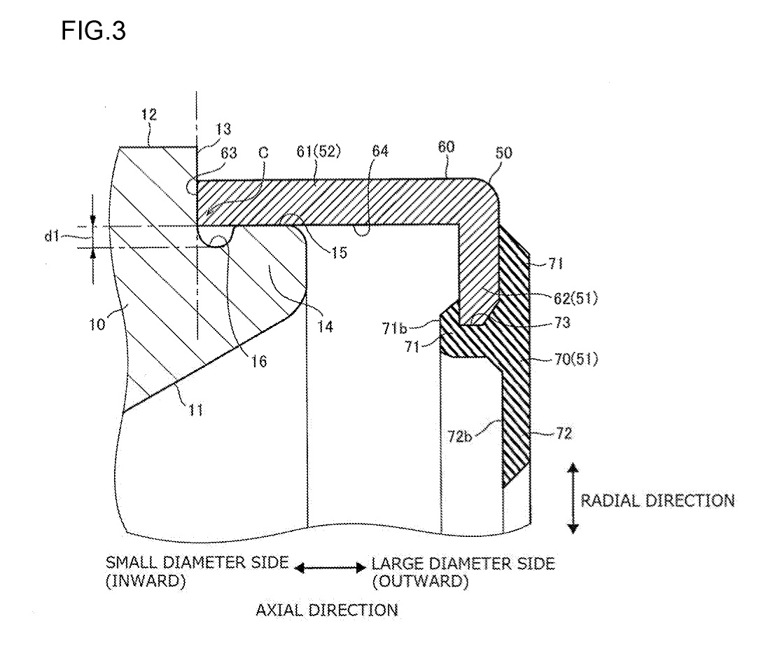

FIG. 3 is a sectional view depicting a part of the lubricant holding member 50 and the outer ring 10. An annular groove 16 is formed at a coupling portion C between the step 13 of the outer ring 10 and the outer peripheral surface 15 of the thin walled portion 14. The groove 16 is formed in the thin walled portion 14 of the outer ring 10. The groove 16 is open outward in the radial direction. An axially inward end of the groove 16 is continuous with the step 13.

A radial depth dl of the groove 16 is preferably set to 2 mm or less in order to suppress a decrease in the strength of the outer ring.

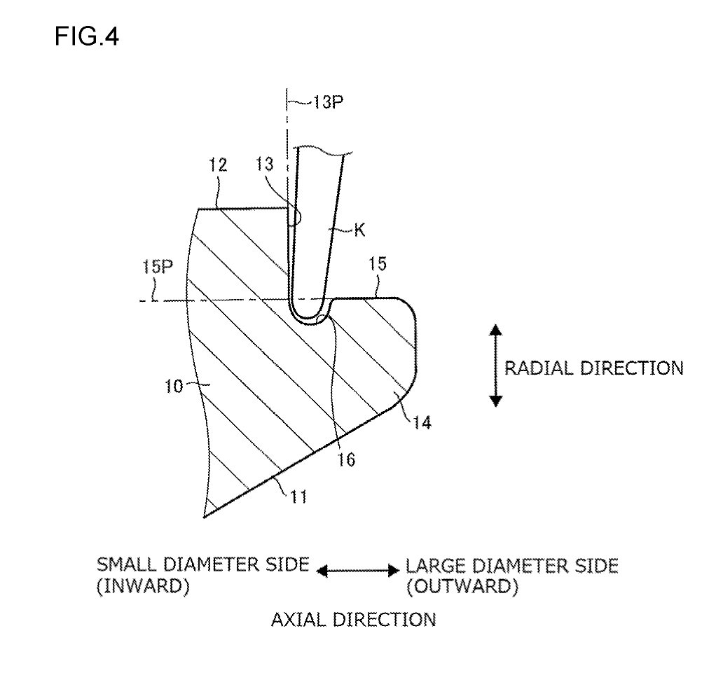

FIG. 4 is a sectional view of the outer ring 10 in which the groove 16 is formed. The groove 16 is formed using a turning tool K with a rounded tip as depicted in FIG. 4. Specifically, the groove 16 is formed by applying the turning tool K to the outer peripheral surface 15 of the thin walled portion 14 and rotating the outer ring 10 around a bearing axis L1 as depicted in FIG. 4.

The above-described procedure is used to form the step 13 on the outer ring 10 while simultaneously forming the groove 16 in the outer ring 10. Thus, even though the turning tool K has the rounded tip, a portion can be completely removed which is located axially outward of a plane 13P that is an extension of a principal surface of the step 13 and radially outward of a plane 15P that is an extension of a principal surface of the outer peripheral surface 15 of the thin walled portion 14.

The inner ring 20 has a second raceway surface 22 on an outer peripheral surface of the inner ring 20 as depicted in FIG. 2. The second raceway surface 22 is tapered such that the distance between the second raceway surface 22 and the bearing axis L1 increases from the small diameter side toward the large diameter side. The taper angle of the second raceway surface 22 is smaller than the taper angle of the first raceway surface 11.

A portion of the inner ring 20 on the small diameter side of the second raceway surface 22 is a cone front face rib portion 25 formed to be larger in radial dimension than a small diameter-side end of the second raceway surface 22 and facing the small end faces 31 of the tapered rollers 30. A portion of the inner ring 20 on the large diameter side of the second raceway surface 22 is a cone back face rib portion 26 formed to be larger in radial dimension than a large diameter-side end of the second raceway surface 22 and facing the large end faces 32 of the tapered rollers 30.

As depicted in FIG. 2, the tapered rollers 30 are arranged in the space formed between the first raceway surface 11 and the second raceway surface 22. As described above, each of the tapered rollers 30 is shaped like a truncated cone, and the roller axis L2 is inclined with respect to the bearing axis L1.

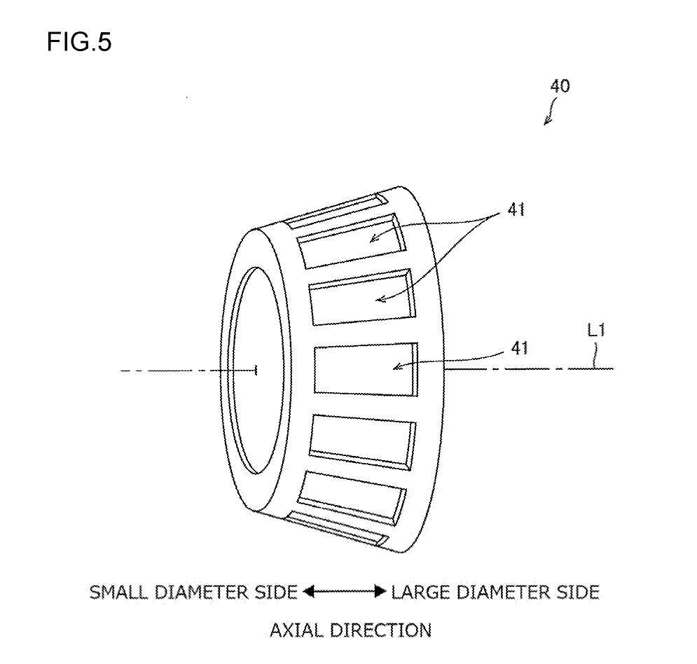

FIG. 5 is a perspective view of the cage 40. The cage 40 is shaped generally like a circular ring having a taper surface such that the distance between the taper surface and the bearing axis L1 increases from the small diameter side toward the large diameter side. A plurality of pockets 41 is formed in the taper surface of the cage 40. Each of the pockets 41 in the taper surface is shaped generally like a trapezoid in association with the shape of each of the tapered rollers 30. The cage 40 is formed of metal or resin.

As depicted in FIG. 3, the lubricant holding member 50 includes a ring 60 and an elastic body lip 70.

The ring 60 includes a cylindrical ring main body 61 and an annular pawl 62 that protrudes inward from an inner peripheral surface of the ring main body 61 in the radial direction. The ring main body 61 and the pawl 62 are integrated together. The bore diameter of the ring main body 61 has an appropriate value to enable the ring main body 61 to be press-fitted externally over the outer peripheral surface 15 of the thin walled portion 14 of the outer ring 10. The pawl 62 is formed outward of the ring main body 61 in the axial direction. The ring 60 is formed of metal, for example, stainless steel.

An axially inward end surface 63 of the ring main body 61 is a circular-ring-like surface arranged generally parallel to the step 13. An inner peripheral surface 64 of the ring main body 61 is a cylindrical surface arranged generally parallel to the outer peripheral surface 15 of the thin walled portion 14 of the outer ring 10.

The elastic body lip 70 is shaped generally like a circular ring. A radially outward portion of the elastic body lip 70 is a thick walled portion 71 that is thicker than the pawl 62 of the ring 60 in the axial direction. A radially inward portion of the elastic body lip 70 is a thin walled portion 72 that is thinner than the thick walled portion 71 in the axial direction. The elastic body lip 70 is formed of rubber, for example, nitrile rubber or acrylic rubber.

In the elastic body lip 70, the thick walled portion 71 and the thin walled portion 72 are integrally formed to be continuous with each other. In other words, on an axially inward surface of the elastic body lip 70, a surface 71b of the thick walled portion 71 is positioned inward of a surface 72b of the thin walled portion 72 in the axial direction.

In the thick walled portion 71, a groove 73 extending inward in the radial direction is formed. The groove 73 is formed all over the circumference of the thick walled portion 71. The size of the groove 73 is set to enable the pawl 62 of the ring 60 to be fitted into the groove 73. The pawl 62 is fitted into the groove 73 to combine the ring 60 and the elastic body lip 70 together, forming the lubricant holding member 50.

Since the ring 60 and the elastic body lip 70 are integrally combined together, the shape of the lubricant holding member 50 corresponds to the integral shape of a circular-ring-like annular portion 51 and a cylindrical portion 52. The annular portion 51 corresponds to the pawl 62 of the ring 60 and the elastic body lip 70. The cylindrical portion 52 corresponds to the ring main body 61.

In the ring 60, the inner peripheral surface 64 of the ring main body 61 contacts the outer peripheral surface 15 of the thin walled portion 14 of the outer ring 10 as depicted in FIG. 3. Additionally, the axially inward end surface 63 of the ring main body 61 is fitted to the large diameter-side end of the outer ring 10 so as to contact the step 13 of the outer ring 10. Consequently, the outer ring 10 and the lubricant holding member 50 are fixed together. Thus, the outer ring 10 and the lubricant holding member 50 rotate integrally around the bearing axis L1.

A lubricant J is fed into a space formed between the lubricant holding member 50 and the outer ring 10 as depicted in a lower part of FIG. 1. The lubricant J is collected in a lower portion of the tapered roller bearing 1. The height of a surface S1 of the lubricant J is equal to the height of the elastic body lip 70 at the lowermost portion of the tapered roller bearing 1.

While the tapered roller bearing 1 remains stationary, the lubricant J is in contact with a part of the outer ring 10, some of the tapered rollers 30, and a part of the cage 40. Rotation of the tapered roller bearing 1 allows the lubricant J collected at the lower portion of the tapered roller bearing 1 to be scooped up in conjunction with the rotation. Consequently, the lubricant J is fed to the first raceway surface 11, the second raceway surface 22, and the like. The thus fed lubricant J reduces friction that may occur, for example, between each tapered roller 30 and the first raceway surface 11 and between each tapered roller 30 and the second raceway surface 22.

In the above-described configuration, the annular groove 16 is formed at the coupling portion between the step 13 of the outer ring 10 and the outer peripheral surface 15 of the thin walled portion 14. Thus, when a step 13 is formed by machining the outer peripheral surface 12 of the outer ring 10 using the turning tool K, then at the coupling portion C between the outer peripheral surface 15 of the thin walled portion 14 and the step 13, the outer ring 10 is machined to a depth below a plane resulting from the intersection of the plane 15P that is an extension of the principal surface of the outer peripheral surface 15 and the plane 13P that is an extension of the principal surface of the step 13. Consequently, when the lubricant holding member 50 is fitted to the outer ring 10 such that the inner peripheral surface 64 of the ring 60 of the lubricant holding member 50 comes into contact with the outer peripheral surface 15 of the thin walled portion 14 of the outer ring 10 and that the axially inward end surface 63 of the ring 60 comes into contact with the step 13 of the outer ring 10, the ring 60 is restrained from being deformed.

The ring 60 is restrained from being deformed when the lubricant holding member 50 is fitted to the outer ring 10. This restrains the ring 60 of the lubricant holding member 50 from being deformed and protruding outward of the outer peripheral surface of the outer ring 10 in the radial direction. Therefore, the above-described configuration enables prevention of problems such as cracking of the outer ring 10 resulting from a load imposed on the outer peripheral surface of the ring 60 and the outer ring 10 during rotation of the bearing, leading to enhanced durability.

The ring 60 is restrained from being deformed when the lubricant holding member 50 is fitted to the outer ring 10. This suppresses formation of an unintended clearance between the outer ring 10 and the lubricant holding member 50. Therefore, the above-described configuration enables the decrease of the sealing performance of the lubricant J to be prevented.

The ring 60 is restrained from being deformed when the lubricant holding member 50 is fitted to the outer ring 10. Consequently, the step 13 of the outer ring 10 stably contacts the axially inward end surface 63 of the ring 60 of the lubricant holding member 50. Therefore, in the above-described configuration, when the tapered roller bearing 1 is assembled to another member such as a housing, the lubricant holding member 50 is restrained from being deflected with respect to the outer ring 10 in spite of an axial force applied to the axially inward end surface 63 of the lubricant holding member 50. As a result, the above-described configuration enables an easy and efficient operation of assembling the tapered roller bearing to another member.

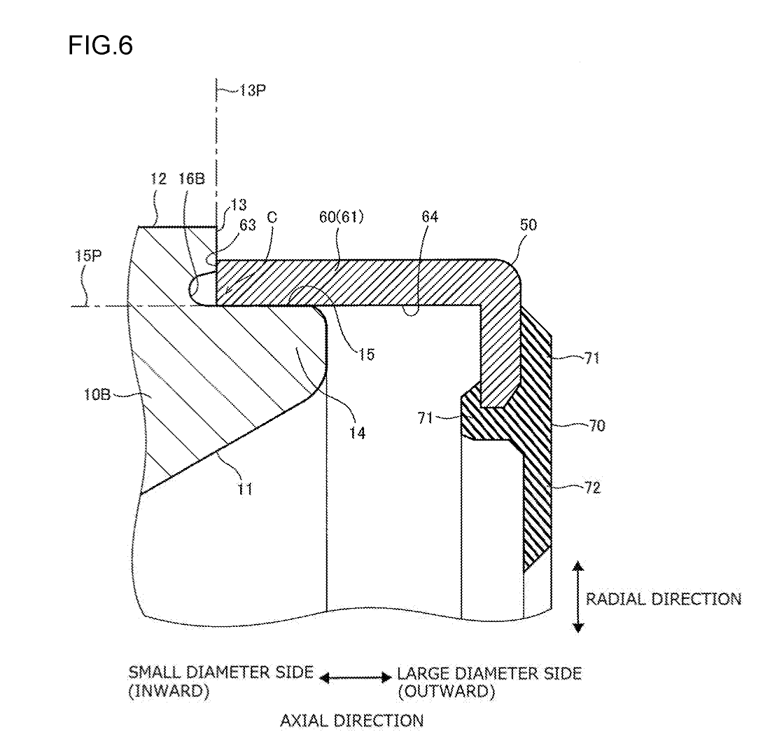

Variations of the first embodiment will be described. FIG. 6 depicts an outer ring 10A and the lubricant holding member 50 in a first variation. The outer ring 10A in the first variation is different from the outer ring 10 in the first embodiment in the shape of the groove 16A.

The groove 16A is formed axially inward of the plane 13P that is an extension of the principal surface of the step 13 and radially inward of the plane 15P that is an extension of the principal surface of the outer peripheral surface 15 of the thin walled portion 14. The groove 16A is open outward both in the radial direction and in the axial direction. A radial depth d2 of the groove 16A is preferably set to 2 mm or less in order to suppress a decrease in the strength of the outer ring 10A.

In the first variation, simultaneously with formation of the step 13 of the outer ring 10A, the groove 16A is formed using a turning tool. This enables complete removal of the portion of the outer ring 10A located axially outward of the plane 13P that is an extension of the principal surface of the step 13 and radially outward of the plane 15P that is an extension of the principal surface of the outer peripheral surface 15 of the thin walled portion 14. Therefore, the ring 60 can be restrained from being deformed when the lubricant holding member 50 is fitted to the outer ring 10A.

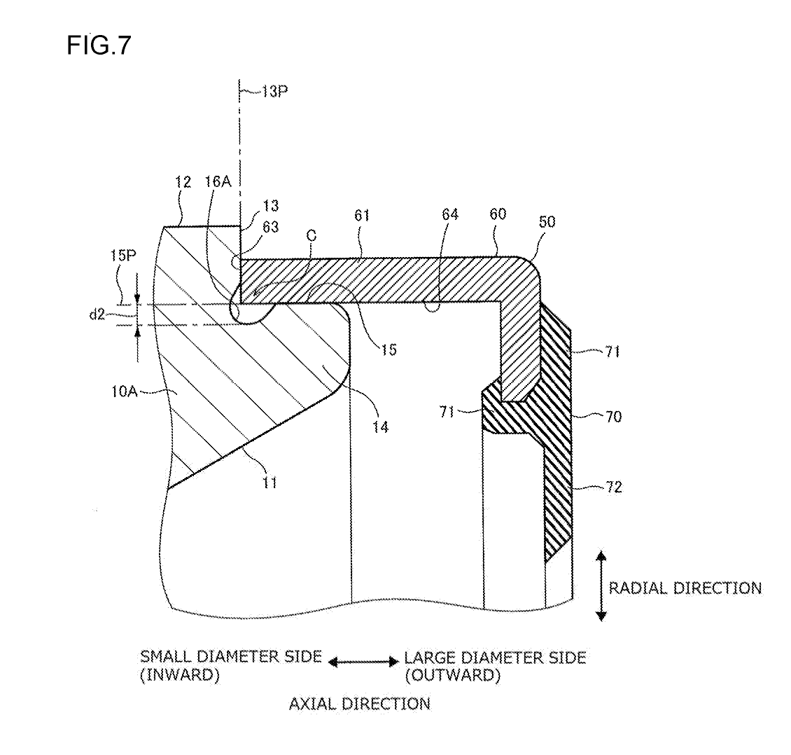

FIG. 7 depicts an outer ring 10B and the lubricant holding member 50 in a second variation. The outer ring 10B in the second variation is different from the outer ring 10 in the first embodiment in the shape of the groove 16B.

The groove 16B is formed in the step 13 of the outer ring 10B. The groove 16B is open outward in the axial direction. A radially inward end of the groove 16B is continuous with the outer peripheral surface 15 of the thin walled portion 14.

In the second variation, simultaneously with formation of the step 13 of the outer ring 10B, the groove 16B is formed using a turning tool. This enables complete removal of the portion of the outer ring 10B located axially outward of the plane 13P that is an extension of the principal surface of the step 13 and radially outward of the plane 15P that is an extension of the principal surface of the outer peripheral surface 15 of the thin walled portion 14. Therefore, the ring 60 can be restrained from being deformed when the lubricant holding member 50 is fitted to the outer ring 10B.

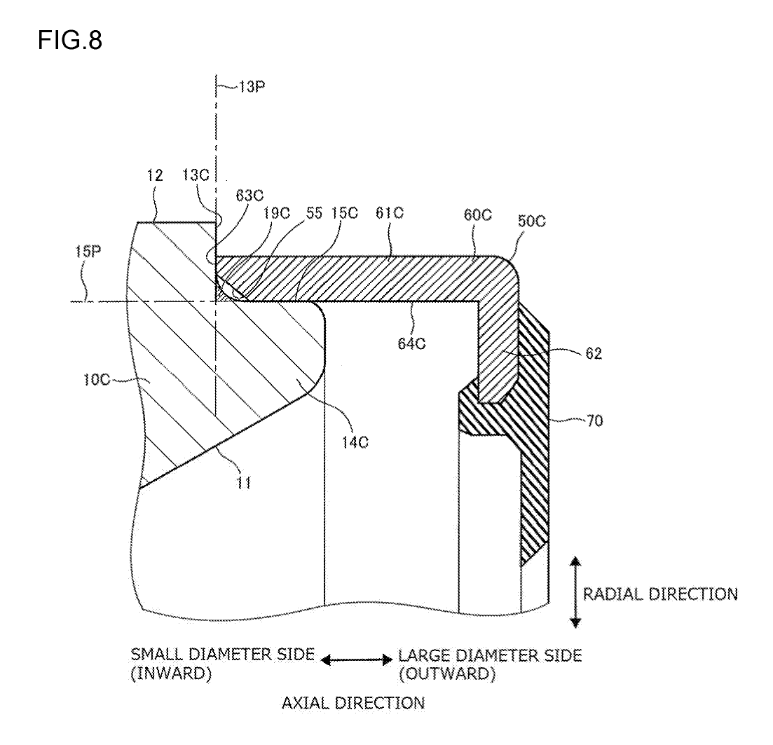

A tapered roller bearing in a second embodiment will be described below. FIG. 8 is a sectional view of a part of an outer ring 10C and a lubricant holding member 50C in the second embodiment. A tapered roller bearing 1C in the second embodiment is different from the tapered roller bearing 1 in the first embodiment in the structure of the outer ring 10C at a coupling portion C between a step 13C of the outer ring 10C and an outer peripheral surface 15C of a thin walled portion 14C and the structure of a ring 60C of a lubricant holding member 50C that corresponds to a portion fitted to the outer ring 10C. The remaining part of the configuration of the second embodiment is the same as the corresponding part of the configuration of the first embodiment.

The outer ring 10C does not have the groove 16 formed in the outer ring 10 in the first embodiment. Thus, the outer ring 10C in the second embodiment has, at the coupling portion C between the outer peripheral surface 15C of the thin walled portion 14C and the step 13C, an unmachined portion 19C resulting from turning is present axially outward of the plane 13P that is an extension of the principal surface of the step 13C and radially outward of the plane 15P that is an extension of the principal surface of the outer peripheral surface 15C of the thin walled portion 14C. In FIG. 8, the unmachined portion 19C is shaded for emphasis.

An annular underfill portion 55 is formed at a coupling portion between an axially inward end surface 63C and an inner peripheral surface 64C of a ring main body 61C of the lubricant holding member 50C.

In the ring main body 61C of the lubricant holding member 50C, the underfill portion 55 is formed as described above. Thus, when the ring main body 61C is fitted to the outer ring 10C, an annular clearance is formed between the plane 13P that is an extension of the principal surface of the step 13C and the plane 15P that is an extension of the principal surface of the outer peripheral surface 15C of the thin walled portion 14C and the underfill portion 55.

As is the case with the first embodiment, the lubricant holding member 50C is fitted to the large diameter-side end of the outer ring 10C such that the inner peripheral surface 64C of the ring main body 61C contacts the outer peripheral surface 15C of the thin walled portion 14C of the outer ring 10C and that the axially inward end surface 63C of the ring main body 61C contacts the step 13C of the outer ring 10C. Consequently, the outer ring 10C and the lubricant holding member 50C are fixed together. Thus, the outer ring 10C and the lubricant holding member 50C rotate integrally.

In this case, the annular clearance is present between the plane 13P that is an extension of the principal surface of the step 13C and the plane 15P that is an extension of the principal surface of the outer peripheral surface 15C of the thin walled portion 14C and the underfill portion 55 as described above. Thus, if the unmachined portion 19C is present at the coupling portion C of the outer ring 10C, the unmachined portion 19C interferes with the ring 60C to allow possible deformation of the ring 60C to be suppressed.

As described above, the ring 60C is restrained from being deformed when the lubricant holding member 50C is fitted to the outer ring 10C. Therefore, as is the case with the first embodiment, a high durability can be achieved for the tapered roller bearing in the second embodiment. The tapered roller bearing in the second embodiment enables the decrease in the sealing performance of the lubricant J to be prevented. The tapered roller bearing in the second embodiment further enables an easy and efficient operation of assembling the tapered roller bearing to another member.

In the above-described embodiments, the lubricant holding member 50 includes the metal ring 60 and the elastic body lip 70. However, the invention is not limited to this. For example, the lubricant holding member 50 as a whole may be formed of an elastic body such as rubber.

The above-described embodiments are only examples that allow the invention to be implemented. Therefore, the invention is not limited to the above-described embodiments but may be implemented by varying the embodiments as needed without departing from the spirits of the invention.

The invention provides a tapered roller bearing that is highly durable and that enables an easy and efficient operation of attaching the bearing to a housing and that prevents the decrease of the sealing performance of the lubricant.

What is claimed is:

1. A tapered roller bearing comprising:
an outer ring having a first raceway surface on an inner peripheral surface of the outer ring and having an annular step provided on an outer peripheral surface of the outer ring and forming an annular thin walled portion at an axial end of the outer ring;
an inner ring having a second raceway surface on an outer peripheral surface of the inner ring and arranged coaxially with the outer ring;
a plurality of tapered rollers arranged in a space between the first raceway surface and the second raceway surface;
a cage that holds the tapered rollers; and
a lubricant holding member fixed integrally to the outer ring, wherein
a lubricant holding member includes:
a circular-ring-like annular portion; and
a cylindrical tubular portion having an axially outward end connected to a radially outward end of the annular portion, the tubular portion being fixed to the outer ring such that an axially inward end surface of the tubular portion contacts the step of the outer ring in an axial direction and that an inner peripheral surface of the tubular portion contacts an outer peripheral surface of the thin walled portion in a radial direction, and
an annular groove is formed at a coupling portion between the step of the outer ring and the outer peripheral surface of the thin walled portion.

2. The tapered roller bearing according to claim 1, wherein
a radial depth of the groove is 2 mm or less.

3. A tapered roller bearing comprising:
an outer ring having a first raceway surface on an inner peripheral surface of the outer ring and having an annular step provided on an outer peripheral surface of the outer ring and forming an annular thin walled portion at an axial end of the outer ring;
an inner ring having a second raceway surface on an outer peripheral surface of the inner ring and arranged coaxially with the outer ring;
a plurality of tapered rollers arranged in a space between the first raceway surface and the second raceway surface;
a cage that holds the tapered rollers; and
a lubricant holding member fixed integrally to the outer ring, wherein
the lubricant holding member includes:
a circular-ring-like annular portion; and
a cylindrical tubular portion having an axially outward end connected to a radially outward end of the annular portion, the tubular portion being fixed to the outer ring such that an axially inward end surface of the tubular portion contacts the step of the outer ring in an axial direction and that an inner peripheral surface of the tubular portion contacts an outer peripheral surface of the thin walled portion in a radial direction, and
an annular underfill portion is formed at a coupling portion between the axially inward end surface of the tubular portion of the lubricant holding member and the inner peripheral surface of the tubular portion.
